(19) United States
(12) Patent Application Publication
(10) Pub. No.: US 2005/0252057 A1
(43) Pub. Date: Nov. 17, 2005

(54) Printed content medium

(76) Inventor: Payam Lavi, Oceanside, CA (US)

Correspondence Address: FISH & RICHARDSON, PC, 12390 EL CAMINO REAL, SAN DIEGO, CA, 92130-2081, US

(21) Appl. No.: 10/844,741

(22) Filed: May 12, 2004

(51) Int. Cl. G09F 3/14

(52) U.S. Cl. 40/665

(57) ABSTRACT

A napkin band is adapted for being wrapped around a napkin folded or wrapped around one or more utensils to hold the components together in a service pack. In an embodiment, a napkin band includes a first end and a second end, an outer surface and an inner surface, and a first attachment area on the inner surface at the first end configured to overlap with and connect face-to-face to a second attachment area on the outer surface at the second end to secure the napkin band in a secured position. The napkin band also includes an interior printed area defined on the inner surface between the first and second ends.

### BACKGROUND

In the food industry, napkin bands are often used to secure a napkin wrapped around silverware. The napkin bands are typically elongated strips of paper with an adhesive attachment area at one or both ends. Napkin bands come in a variety of colors, and some include printed content such as logos, names, etc., on the outer side of the napkin band that projects outward from the wrapped utensils.

### SUMMARY

A printed content medium and method of forming the same are disclosed. The printed content medium includes a napkin band having a first end, a second end, an outer surface and an inner surface. The printed content medium further includes an interior printed area defined on the inner surface between the first and second ends, and having printed content. The medium further includes a first attachment area on the inner surface at the first end configured to overlap and connect face-to-face to a second attachment area on the outer surface at the second end to secure the napkin band in a secured position.

In an alternative exemplary embodiment, a method of forming a printed content medium includes the step of providing a napkin band having a first end and a second end, an outer surface and an inner surface, and a first attachment area on the inner surface at the first end configured to overlap with and connect face-to-face to a second attachment area on the outer surface at the second end to secure the napkin band in a secured position. The method further includes the step of applying print content to an interior printed area defined on the inner surface between the first and second ends.

The details of one or more embodiments are set forth in the accompanying drawings and the description below. Other features, objects, and advantages will be apparent from the description and drawings, and from the claims.

### BRIEF DESCRIPTION OF THE DRAWINGS

These and other aspects will now be described in detail with reference to the following drawings.

FIGS. 1A and 1B show both sides of a napkin band.

FIG. 2 shows a napkin band in a secured position.

FIG. 3 illustrates a napkin band and service pack.

FIG. 4 is a flowchart of a method of forming and using a napkin band with an interior printed area.

Like reference symbols in the various drawings indicate like elements.

### DETAILED DESCRIPTION

A device and method are disclosed for presenting printed content. In accordance with one exemplary embodiment, a napkin band is configured to be wrapped and secured around a napkin that holds one or more utensils. In the secured position, an inner surface of the napkin band faces inward toward the napkin, and an outer surface faces outward. The napkin band includes a printed area defined on the inner surface.

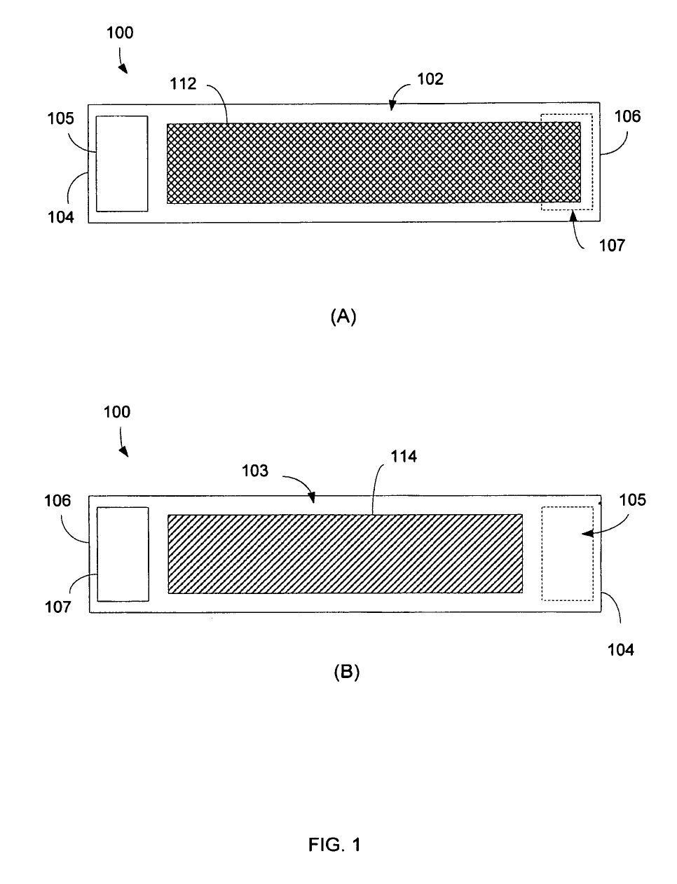

FIGS. 1A and 1B show front and back views, respectively, of a napkin band 100 and a printed content medium formed thereof. FIG. 1A shows a outer surface 102, and FIG. 1B shows an inner surface 103 of the same napkin band 100. The napkin band 100 includes a first end 104 and a second end 106, and a first attachment area 105 proximate the first end 104. The first attachment area 105 can be provided with a glue or sticky coating for securing to a second attachment area 107 on the opposing inner surface 103 of the napkin band 100 proximate the second end 106 (and shown as a dotted line in FIG. 1A). The second attachment area 107 may also be provided with a glue or sticky coating. The outer surface 102 may include a printed area 112 that can include coloring, logos, text, or graphics, or other printed content.

The inner surface 103 of the napkin band 100 includes an interior printed area 112. The interior printed area 112 can include coloring, logos, text, graphics, or the like, which is revealed to a customer when the napkin band is not in a secured position. In one embodiment, the interior printed area 112 is defined between the first end 104 and the second end 106, preferably (but not necessarily) within the inner surface 103 exclusive of the first attachment area 105 and second attachment area 107.

FIGS. 1A and 1B show a napkin band 100 that is generally elongated and rectangular, however it should be understood that the napkin band 100 can be of any shape or configuration. In an exemplary embodiment, the napkin band 100 is constructed of paper, however can be formed of any resilient yet bendable material, such as a thin sheet of plastic.

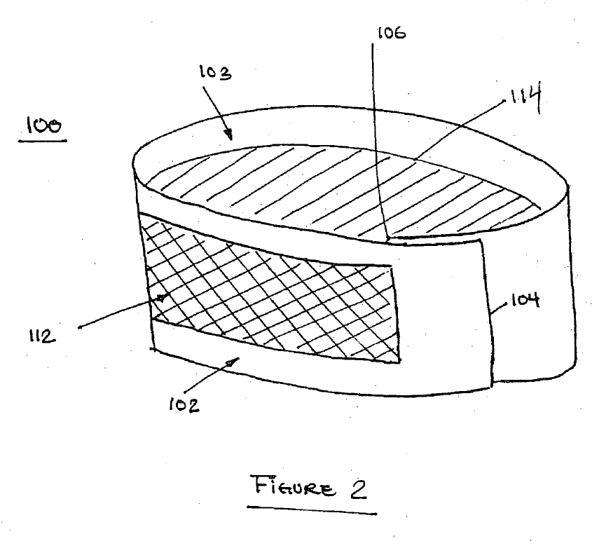

FIG. 2 illustrates the napkin band 100 in the secured position, in which the first attachment area 105 at the first end 104 overlaps and connects face-to-face to the second attachment area 107 at the second end 106. It should be recognized that the secured position may also be achieved with second attachment area 107 overlapping the first attachment area 105. In the secured position, the outer surface 102 faces outward from the napkin band 100, and the inner surface 103 faces in. Accordingly, the interior printed area 114 is provided on the inside of the “ring” formed by the napkin band 100 in the secured position, and can be revealed to a customer when the napkin band 100 is removed from the secured position.

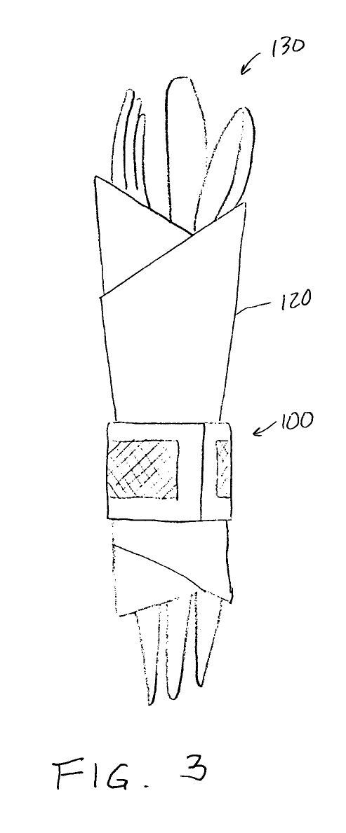

FIG. 3 shows a napkin band 100 in the secured position secured about a napkin 120 that has been folded or rolled around one or more utensils 130. In this configuration, the napkin band 100, napkin 120 and one or more utensils 130 form a “service pack” for use in restaurants, hotels, casinos, or any other food service establishment. Accordingly, the interior printed area provides a valuable space for including printed content such as coupons, restaurant information such as food information, new products, discounts, etc. The interior printed area can also include logos, promotional or cross-promotional information, entertainment content such as games, riddles, etc., or even important telephone or web-site information.

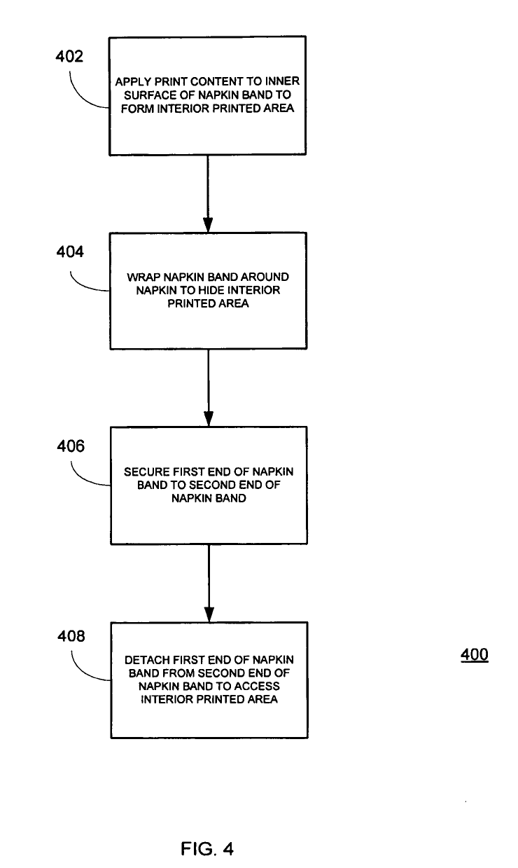

FIG. 4 illustrates a method 400 of making and using a napkin band having an interior printed area. At 402 print content is applied to an inner surface of a napkin band to form the interior printed area. The print content can be applied individually, or in a continuous printing machine. At 404, the napkin band is wrapped around a napkin, where the interior printed area is at least partially hidden from view of a customer. According to one option, the napkin band can be provided in a cartridge for wrapping around one napkin from a stack or roll of napkins. This wrapping around can be automatic (by machine) or manual. At 406, a first end of the napkin band is secured to a second end of the napkin band, which may be according to the mechanisms described above. Once so secured, the napkin band holds a “service pack” for distribution to customers.

At 408, the first and second ends of the napkin band can be detached to allow access to the interior printed area on the inner surface of the napkin band. Thus, a customer can pull one or both sides of the napkin band apart to gain view the inner surface and the print content provided thereon. The feature of the interior printed area being hidden from view of a customer when the napkin band is in the secured position lends itself to use of the napkin band for games of chance, surprises, etc.

Although a few embodiments have been described in detail above, other modifications are possible. Other embodiments may be within the scope of the following claims.

1. A printed content medium, comprising:
a napkin band having a first end, a second end, an outer surface and an inner surface;
an interior printed area defined on the inner surface between the first and second ends, the printed area having printed content;
a first attachment area on the inner surface at the first end configured to overlap and connect face-to-face to a second attachment area on the outer surface at the second end to secure the napkin band in a secured position.

2. A medium in accordance with claim 1, further comprising an exterior printed area defined on the outer surface between the first and second ends.

3. A medium in accordance with claim 1, wherein the interior printed area is disposed on an inside of the napkin band in the secured position.

4. A medium in accordance with claim 2, wherein the interior printed area is disposed on an inside of the napkin band in the secured position, and wherein the exterior printed area is disposed on an outside of the napkin band in the secured position.

5. A napkin band, comprising:
a first end and a second end;
an outer surface and an inner surface;
a first attachment area on the inner surface at the first end configured to overlap with and connect face-to-face to a second attachment area on the outer surface at the second end to secure the napkin band in a secured position; and
an interior printed area defined on the inner surface between the first and second ends.

6. A napkin band in accordance with claim 5, wherein the interior printed area includes printed content.

7. A napkin band in accordance with claim 6, wherein the printed content includes at least one color.

8. A napkin band in accordance with claim 6, wherein the printed content includes text.

9. A napkin band in accordance with claim 6, wherein the printed content includes a coupon.

10. A napkin band in accordance with claim 6, wherein the printed content includes food and/or restaurant-related information.

11. A napkin band in accordance with claim 6, wherein the printed content includes entertainment-related content.

12. A napkin band in accordance with claim 6, wherein the printed content includes customer relations information.

13. A napkin band in accordance with claim 6, wherein the printed content includes at least one logo.

14. A method of forming a printed content medium, comprising:
providing a napkin band having a first end and a second end, an outer surface and an inner surface, and a first attachment area on the inner surface at the first end configured to overlap with and connect face-to-face to a second attachment area on the outer surface at the second end to secure the napkin band in a secured position; and
applying print content to an interior printed area defined on the inner surface between the first and second ends.

15. A method in accordance with claim 14, further comprising defining the interior printed area to receive the print content.

16. A method in accordance with claim 14, further comprising securing the napkin band around a napkin in the secured position.

17. A method in accordance with claim 16, further comprising disengaging the first attachment area from the second attachment area to provide access to the interior printed area.
